(19) United States
(12) Patent Application Publication
(10) Pub. No.: US 2002/0188505 A1
(43) Pub. Date: Dec. 12, 2002

(54) Electronic coupon and customer data acquisition apparatus and method

(76) Inventor: Philip H. Burrus IV, Lilburn, GA (US)

Correspondence Address: Motorola Energy Systems Group, Intellectual Property, 1700 Belle Meade Court, Lawrenceville, GA, 30043, US

(21) Appl. No.: 09/876,504

(22) Filed: Jun. 7, 2001

(51) Int. Cl. G06F 17/60; G06K 5/00

(52) U.S. Cl. 705/14; 705/28; 235/380

(57) ABSTRACT

This invention includes an apparatus and method for an electronic savings card. Two preferred systems are discussed: A Store Method and A Cellular Carrier Method. In the store method, a portable electronic device, like a cellular phone for example, transmits user data to the store's cash register identifying the shopper. The store's cash register then discounts the customer's bill accordingly and may optionally transmit customer and product data to a central computer. In the Cellular Carrier Method, the store's cash register transmits store identification data to a cellular phone. The cellular phone then sends store, customer and product data to the cellular carrier for data processing. The data is then sent in the form of customized reports to the store and to product manufacturers, thereby allowing the store and product manufacturer to reduce headcount and save data processing and infrastructure costs.

### BACKGROUND

### 1. Technical Field

This invention relates generally to electronic coupons, and more specifically to vendor specific electronic coupons and customer data acquisition systems related to vendor specific electronic coupons.

### 2. Background Art

Many stores today offer custom “savings cards”, or electronic coupon cards, to their customers. For example, the Harris-Teeter® supermarket offers a VIC® card. Customers sign up for the card at the store by filling out an application form. On the application form, the customer gives the store giving the company enough personal information to identify the customer. This may include name, age, address, telephone number, and the like. The store then issues the customer a card having a unique identifier. This identifier is often a machine-readable bar code having a unique identification code. The customer then presents the card to the cashier each time they shop.

The store periodically puts various items on sale. Typically these items are advertised with a savings sign in the store. These marked-down prices may be offered by the store itself or, in the alternative, may be in conjunction with a particular manufacturer's promotion. As the customer proceeds through the store, they pick and choose between the sale items and the regularly priced items.

When the customer checks out, they typically first present their savings card to the clerk. The clerk scans the card into the register, a process that identifies the customer. After the groceries are totaled, the register subtracts the sale amounts applicable to all specially marked items. The receipt then lists the “pre-savings total”, less the savings card savings, as the total due. The customer is instantly aware of the benefit of shopping with the card.

Such cards work as a win-win for all parties involved. For the customer, the card acts as a “super coupon” in that it offers discounts to a wide array of products without the hassle of carrying around many paper coupons. For the retailer, the card offers an incentive for the customer to return to the store. It also works as an advertising tool.

A predominant benefit of the card is that the retailer is able to gather information about its customer. In some cases, the retailer and various manufacturers may build a database profile of each customer. For example, when Joe Smith presents his VIC® card, the register instantly identifies him, as well as the list of ALL of his purchases. (Note: while the customer only gets discounts on the specially marked items, the retailer now has a name, address, and phone number to go with every item purchased.) Over a period of years, a comprehensive profile can be built on every customer. This profile is of great value in that it can both help tailor advertising campaigns and also be sold to other manufacturers.

The problem with these cards, however, is that they have become too prevalent and thus are falling out of favor. Gas stations, grocery stores, specialty stores, etc., all have savings cards. While the customer was initially able to carry one card instead of hundreds of coupons, the customer must now carry a stack of savings cards depending upon the number if stores he or she shops.

This large number of cards results in the customer turning down savings cards at all locations except those that the customer frequently visits. For example, even though a store might offer the customer a savings card, he or she might reply, “I've got too many darned cards already. My wallet is as thick as the Internal Revenue Code. I don't need another stinking card.” The result of this conversation is that the customer misses out on a great deal of savings, and the merchants miss out on a great deal of information.

There is thus a need for an improved savings card.

### BRIEF DESCRIPTION OF THE DRAWINGS

FIG. 1 is an illustration of a preferred embodiment in accordance with the invention.

FIG. 2 is an illustration of an alternate preferred embodiment in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

A preferred embodiment of the invention comprises two parts: The first is a cellular phone having two-way communication capability or an electronically readable unique identifier, wherein the phone includes an embedded savings card. The second part is a method of customer data acquisition using the embedded savings card.

Cellular phones are capable of two-way communication. For example, the phone transmits digital information through a variety of protocols, including CDMA, TDMA, and GSM. Additionally, there are plans in place by companies such as Motorola and Nokia to include a Bluetooth universal communications module in the phones. Many phones have infrared communication ports as standard equipment. Some phones include docking ports as well. Additionally, cellular phones can store data. Many phones on the market include memories for storing data including phone lists, e-mail, text messages, calendar data, memos, and the like.

Cellular phones are also capable of identifying the user. For example, when a person makes a cellular call, one of the first bits of data that gets transmitted is the caller's telephone number. This number is then linked with the data in the telephone company's file to provide such information as the caller's name on caller ID systems.

This invention uses the communication and data storage capabilities of the phone in a novel manner to serve as a universal savings card. In addition to using the phone as a universal savings card, this invention includes data acquisition for customer profiling. Alternate embodiments include data compilation by the merchant and data compilation by the cellular service provider. Instead of having a paper savings card for every store, the person simply uses the phone's two-way communication capability to interact with a merchant's cash register. The phone may then transfer the phone number to the store to identify customer or, in the alternative, the store may identify itself to the phone. Then either the phone service provider or register system may cross reference the information and process the corresponding data. This is best explained by example:

A first preferred embodiment: The Store Method

In this embodiment, the phone works predominantly in the same manner that a savings card does. When a customer wants a savings card from a particular store, he gives the traditionally required personal information to the store. This is typically done by filling out a form. Instead of issuing the customer a paper savings card, the merchant logs the customer's telephone number into the central computer of the store. (This is the same as with a paper savings card, however instead of identifying the customer by a bar code, the store identifies the customer by cellular telephone number.)

The customer then goes about his shopping. When the customer approaches the register, the phone transfers the identifying personal data to the store's cash register and ultimately to the store's central computer. This communication can be done in a number of ways: GSM, CDMA, TDMA, or G3 radio-frequency (RF) protocols; infrared communications; Bluetooth communications; directly coupling to a physical port. Additionally, a simulated credit card swipe may be attached to the phone. This simulated credit card swipe may be swiped through a reader. Such a simulated credit card swipe is disclosed in U.S. Pat. No. 4,791,283, issued to Burkhardt, entitled “Transaction card magnetic stripe emulator”. The phone may include a security personal identification number (PIN) that must be entered prior to the transmission of personal data.

In one preferred embodiment, the personal identification information is simply the cellular phone's telephone number. Once the identification data is transferred to the cash register, the store's computer system can cross reference the customer information in the system in the same manner that discount cards are processed today. The processing may include product discounts, consumer buying behavior and inventory management.

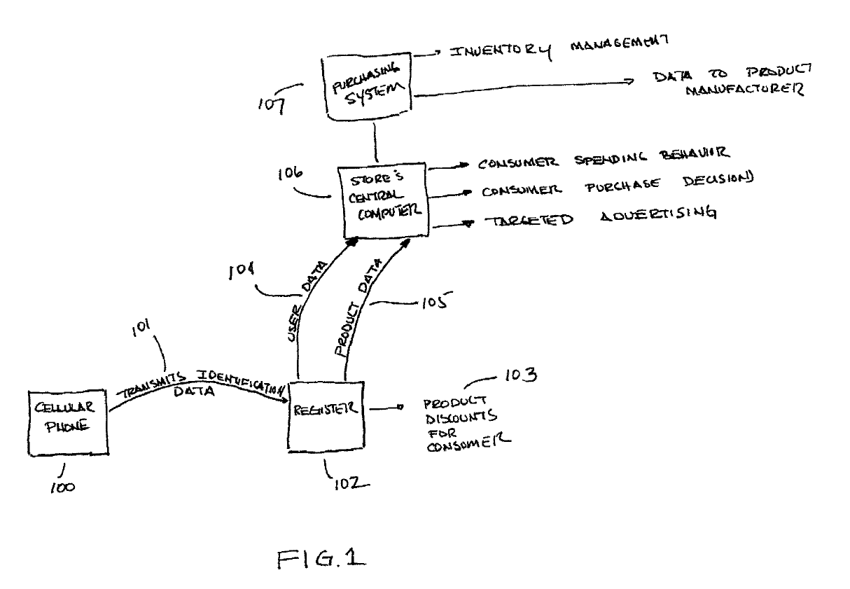

Referring now to FIG. 1, illustrated therein is one preferred embodiment of the invention illustrating the Store Method. At the checkout point the customer's cellular phone 100 transmits the customer identification data 101 to the store's cash register 102. The store's cash register 102 processes the information locally, including discounting the products 103 for the customer.

The store's cash register may also send the user data 104 and product data 105 (e.g what products the customer purchased, quantity, etc.) to the store's central computer 106. The store's central computer 106 may track this data in a database or other data processing tool. This data processing may include reports on consumer spending behavior, purchasing decisions, success of advertising campaigns, demographic data, as well as data for future advertising campaigns. The information may also be shared with the store's purchasing system 107 to make ordering decisions. It may also go to manufacturers. For example, Kelloggs may be interested in how its corn flakes are selling in Georgia.

Scenario 2: The Cellular Carrier Method

Many cellular phones today are dual mode, which means that they transmit in two different areas of the RF spectrum. For example, the phone may communicate via one protocol at a specific frequency, or the phone may use a different frequency (where applicable) via a spread spectrum. Often there is tremendous unused bandwidth in the spread spectrum. Cellular providers have come up with novel promotions to help utilize this spectrum. For example, Cingular now offers service wherein you can talk to any other Cingular customer free with unlimited talk time.

In the Cellular Carrier Method, the phone actually provides a connection from the store location to either the cellular provider or a host database to retrieve and send information. This communication is via the spread spectrum and no cost to the user. Instead of the phone identifying the customer to the store as in the Store Method, in the Cellular Carrier Method the store identifies itself to the phone. The phone then transmits store information, customer information and product information to a central computer at the cellular service provider. The cellular provider is then able to process the data and provide a detailed report to the store and the product vendors as a value added service. If one particular store carries a cellular service provider exclusively, the data processing (reducing the store's infrastructure costs and head count) could serve as consideration for the exclusive arrangement.

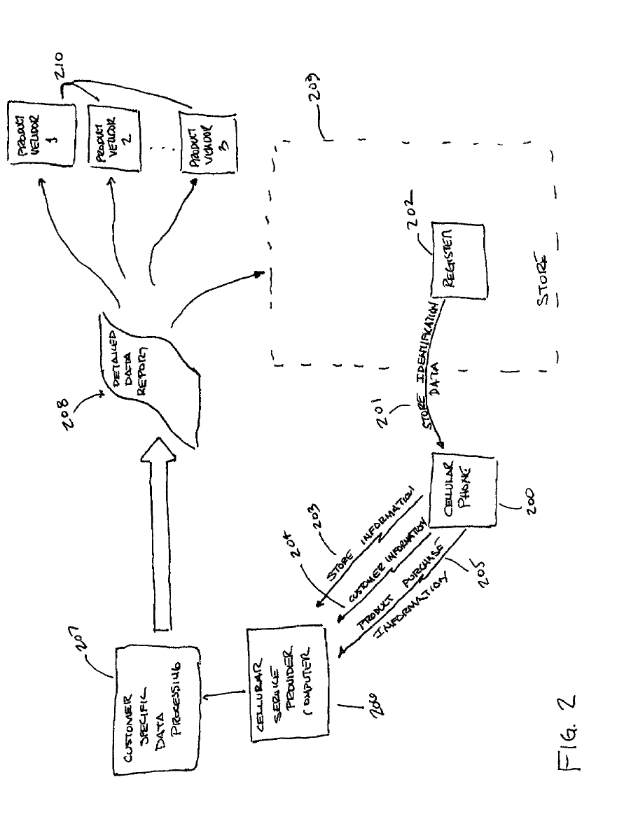

Referring now to FIG. 2, illustrated therein is the Cellular Carrier Method in accordance with the invention. At the checkout point the store's cash register 202 transmits store identification data 201 to the customer's cellular phone 200. When an acknowledgement or electronic handshake is recognized by the cash register 202, the register makes the appropriate discounts. The customer's cellular phone 200 then transmits store data 203 customer data 204 and product data 205 to the cellular service provider's computer 206.

The cellular service provider then processes the data in a data processing system 207 (either internally or as an outsourced operation) per the requirements of the store or manufacturer. The data processing output may include customized reports 208 of consumer spending behavior, purchasing decisions, inventory management reports, success of advertising campaigns, demographic data, and the like, as well as data for future advertising campaigns. Specific reports 208 may also be prepared for the product vendors 210. This data processing service allows both the store and product manufacturer to save costs and reduce headcount by outsourcing the preparation of this extremely valuable information.

It will be obvious to one skilled in the art that the electronic coupon system can be implemented in a variety of ways. For example, in a hybrid method, as opposed to giving the merchant the information, a network may be installed at the merchant's site. This network is similar to the credit card network currently installed (in fact, the new network could piggy back on the credit card network). When the customer's phone transfers the identifying data to the store, the store network would then connect with the cellular telephone provider and download the personal data. This data would be a subset of the data the phone company already maintains. For example, it may only include name and address.

Additionally, in another alternate method, customer information may be simply stored in the phone's memory. When the customer approaches the register, the phone simply transmits name and address in addition to the number.

All the scenarios offer a marketing advantage for each the phone manufacturer, the store, product manufacturers and the cellular service provider adopting this technology. Recall that one advantage of a savings card is the fact that it provides the customer with an incentive to patronize a particular chain. This advantage is offset, however, by the reluctance of customers to carry more than one card. This invention offers a means to generate demand-pull for the service. Just as automated teller machines (ATM) are networked, so could be merchants. In the ATM world, when you use your ATM card at a machine not within your network, you are often charged a transaction fee. However, if your bank is a member of the Cirrus network, you will not be charged a transaction fee when you patronize a Cirrus machine. Consequently, people tend to seek out the machines that are members of their network.

The same brand name recognition for this invention would cause customers to seek out stores that had the system. This saves the need for carrying many savings cards. For example, imagine that Publix supermarket accepts the “Motorola Cellular Savings Card”. A sign in the window might read “Motorola Cellular Savings Network Member.” The customer then knows that all they need is to present their cellular phone to enter a world of savings. Likewise, when the customer goes shopping for clothes, hardware, gas, or pet products, they simply look for the “Motorola Cellular Savings Network Member” sign. This is assurance that their phone will be accepted as a coupon.

The invention provides benefits for all parties involved: The customer gets increased savings without the need of signing up and carrying many savings cards. They also have assurances of confidentiality in that a name brand cellular service provider or cellular telephone manufacturer sponsors the network. They can be assured that intimate personal information, like social security numbers for instance, will not be revealed.

For the Store and product manufacturer, the same advantages are present as with conventional cards. There are additional advantages in that the store has less paperwork, an enhanced advertising point that results from the name brands, and less reluctance for the customer not to use his savings card.

The invention gives the cellular phone manufacturer instant partnering opportunities to promote the brand name. In addition, the invention gives the cellular phone manufacturer a competitive advantage over other manufacturers.

Additional services could be equally provided. For example, credit card information could be stored in the phone. When the phone number was transmitted, the credit card information could be transmitted as well, again reducing the number of steps the consumer needs to take. Next, the product information could be loaded into the phone as well. Customers could then download this into Excel or Quicken to help plan their monthly budgets.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. For example, while the invention has been recited relating to cellular telephones, this is for exemplary purposes only. The invention could easily be adopted to two-way radios, personal digital assistants, and the like.

What is claimed is:

1. An electronic savings card system, the system comprising a portable electronic device having unique personal identification data stored therein.

2. The system of claim 1, further comprising a store register.

3. The system of claim 2, wherein the portable electronic device transmits the personal identification data to the store register.

4. The system of claim 3 wherein the portable electronic device comprises a cellular telephone.

5. The system of claim 4, wherein the store register discounts a price of a product as a result of receiving the unique personal identification data.

6. A method of acquiring customer data, the method comprising the steps of:
a. providing a portable electronic device having unique personal identification data stored within, wherein the portable electronic device comprises a means of transmitting the unique personal identification data;
b. providing a store register capable of receiving the unique personal identification data;
c. transmitting the unique personal identification data from the portable electronic device to the store register; and
d. discounting a price of at least one product upon receipt of the unique personal identification data.

7. The method of claim 6, further comprising the steps of:
a. providing a central computer;
b. transmitting the unique personal identification data to the central computer; and
c. cross referencing the unique personal identification data with a stored data profile.

8. The method of claim 7, further comprising the steps of:
a. transmitting product data from the store register to the central computer; and
b. storing the product data with a cross reference to the unique personal identification data.

9. The method of claim 7, wherein the product data is used for inventory management.

10. A method of acquiring customer data, the method comprising the steps of:
a. providing a store register capable having unique store identification data stored within, wherein the store register comprises a means of transmitting the unique store identification data;
b. providing a personal electronic device capable of receiving the unique store identification data;
c. transmitting the unique store identification data from the store register to the portable electronic device; and
d. discounting a price of at least one product upon successful transmission of the unique store identification data.

11. The method of claim 10, further comprising the steps of:
a. transmitting the unique store identification data from the personal electronic device to a remote computer;
b. transmitting customer data from the personal electronic device to a remote computer; and
c. transmitting product data from the personal electronic device to a remote computer.

12. The method of claim 11, further comprising the steps of:
a. processing the unique store identification data, the customer data and the product data; and
b. producing a report with the unique store identification data, the customer data and the product data listed in an organized format.

13. The method of claim 12, wherein the personal electronic device comprises a cellular telephone.

14. The method of claim 13, wherein the store register is linked to at least one other store register via a network.

15. The method of claim 14, further comprising the step of distributing advertising literature based upon the report.

16. The method of claim 14, further comprising the step of using the report for inventory management.
